(19) United States
(12) Patent Application Publication
(10) Pub. No.: US 2017/0249093 A1
(43) Pub. Date: Aug. 31, 2017

(54) STORAGE METHOD AND DISTRIBUTED STORAGE SYSTEM

(71) Applicant: SurCloud Corp., Union City, CA (US)

(72) Inventors: Donglin WANG, Tianjin (CN); Yu QI, Tianjin (CN)

(21) Appl. No.: 15/594,374

(22) Filed: May 12, 2017

Related U.S. Application Data
(63) Continuation-in-part of application No. 15/055,373, filed on Feb. 26, 2016.
Application No. 15/055,373 is a continuation of application No. PCT/CN2014/085218, filed on Aug. 26, 2014.
Application No. PCT/CN2014/085218 is a continuation-in-part of application No. 13/858,489, filed on Apr. 8, 2013, now abandoned.
Application No. 13/858,489 is a continuation of application No. PCT/CN2012/075841, filed on May 22, 2012.
Application No. PCT/CN2012/075841 is a continuation of application No. PCT/CN2012/076516, filed on Jun. 6, 2012.
Application No. PCT/CN2012/076516 is a continuation-in-part of application No. 13/271,165, filed on Oct. 11, 2011, now Pat. No. 9,176,953.
(60) Provisional application No. 61/621,553, filed on Apr. 8, 2012.

(30) Foreign Application Priority Data
May 2, 2012 (CN) 201210132926.7
May 16, 2012 (CN) 201210151984.4
Aug. 26, 2013 (CN) 201310376041.6
Aug. 26, 2014 (CN) 201410422496.1
Feb. 16, 2017 (CN) 201710082890/9

(51) Int. Cl. G06F 3/06

(52) U.S. Cl. CPC G06F 3/0619; G06F 3/065; G06F 3/0641; G06F 3/0659; G06F 3/067

(57) ABSTRACT

Embodiments of the present invention provide a storage method and a distributed storage system. The storage method is applied to the distributed storage system comprising at least two storage control nodes and one storage pool shared by at least two storage control nodes. The storage pool includes at least two storage units. When data is to be written to the storage pool by any one of storage control nodes, the method comprises judging whether or not there exists a duplicate storage unit whose data content is the same as the currently-written data in the storage pool, and allocating one free storage unit from the storage pool and writing the currently-written data to the free storage unit when judgment result is NO.

### CROSS-REFERENCE TO RELATED APPLICATIONS

This application claims the benefit and priority of Chinese patent application No. 201710082890.9 filed on Feb. 16, 2017, and is also a continuation-in-part of U.S. patent application Ser. No. 15/055,373 filed on Feb. 26, 2016, which is a continuation of International Patent Application No. PCT/CN2014/085218 filed on Aug. 26, 2014, which claims priority of Chinese Patent Application No. 201310376041.6 filed on Aug. 26, 2013 and Chinese Patent Application No. 201410422496.1 filed on Aug. 26, 2014, and is also a continuation-in-part of U.S. patent application Ser. No. 13/858,489 filed on Apr. 8, 2013, which is a continuation of PCT/CN2012/075841 filed on May 22, 2012 claiming priority of Chinese patent application 201210132926.7 filed on May 2, 2012, which is also a continuation of PCT/CN2012/076516 filed on Jun. 6, 2012 claiming priority of Chinese patent application 201210151984.4 filed on May 16, 2012, which claims priority to U.S. Provisional Patent Application No. 61,621,553 filed on Apr. 8, 2012, and which is continuation-in-part of U.S. patent application Ser. No. 13/271,165 filed on Oct. 11, 2011, the contents of which are incorporated herein by reference.

### TECHNICAL FIELD

Embodiments of the present invention relate to the technical field of data storage, and in particularly to a storage method and a distributed storage system.

### BACKGROUND

With the increasing scale of computer applications, the demand for storage space is also on the increase. Correspondingly, it becomes common that storage resources of a plurality of devices, e.g., storage media of disk groups, are integrated as one storage pool to provide storage services. However, in a distributed storage system comprising a plurality of storage control nodes, although there is no conflict when the plurality of storage control nodes perform read operations on the same storage unit in the storage pool simultaneously, there is conflict when the plurality of storage control nodes perform write operations on the same storage unit simultaneously, or there is conflict when two storage control nodes perform a read operation and a write operation separately on the same storage unit in the storage pool simultaneously. Thus, there is an urgent need for a storage method that avoids the above conflict to ensure efficiency and quality of storage procedures.

### SUMMARY

In view of this, embodiments of the present invention provide a storage method and a distributed storage system, to solve conflict problems between read operations and write operations, and between write operations and write operations, which are caused by the existing storage methods.

The storage method according to an embodiment of the present invention is applied to a distributed storage system comprising at least two storage control nodes and a storage pool shared by the at least two storage control nodes, the storage pool including at least two storage units, the method comprises: judging whether or not there exists a duplicate storage unit whose data content is the same as the currently-written data in the storage pool when the currently-written data is to be written into the storage pool by any one of the storage control nodes, and allocating a free storage unit from the storage pool and writing the currently-written data into the free storage unit when the judgment result is NO.

The distributed storage system according to an embodiment of the present invention includes at least two storage control nodes and one storage pool shared by the at least two storage control nodes. The storage control nodes comprises: a judgment module configured to judge whether or not there exists a duplicate storage unit whose data content is the same as currently-written data in the storage pool; a free unit management module configured to allocate one free storage unit from the storage pool; and a writing module configured to return a storage address of the duplicate storage unit when the judgment result returned by the judgment module is YES; otherwise to write the currently-written data to the free storage unit allocated by the free unit management module, and to return the storage address of the free storage unit to which the currently-written data has been written.

The storage method and the distributed storage system according to embodiments of the present invention first judge whether or not there exists a duplicate storage unit whose data content is the same as the currently-written data each time data is to be written to the storage pool by the storage control nodes. If there exists no duplicate storage unit in the storage pool, it means that the currently-written data is new data content that is not stored in the storage pool, the currently-written data is written to one free storage unit at the time. In this way, read operations performed by other storage control nodes simultaneously can still read original data contents from the current storage unit, and other write operations performed by other storage control nodes simultaneously can write another write data in another free storage unit. Thus, by the storage method according to embodiments of the present invention, there is no conflict between read operations and write operations, and between write and write operations, thereby effectively ensuring efficiency and quality of data content storage. At the same time, the judging process of the duplicate storage unit avoids duplicate storage of the data contents, saves storage space, and improves utilization efficiency of storage resources.

### BRIEF DESCRIPTION OF DRAWINGS

FIG. 1 shows a schematic flowchart of a storage method according to an embodiment of the present invention.

FIG. 2A shows a schematic view illustrating a principle of a storage method according to an embodiment of the present invention.

FIG. 2B shows a schematic view illustrating a structure of a storage object according to an embodiment of the present invention.

FIG. 3 shows a schematic flowchart of a storage method according to another embodiment of the present invention.

FIG. 4 shows a schematic flowchart of judging whether or not there is a duplicate storage unit in a storage method according to an embodiment of the present invention.

FIG. 5 shows a schematic view illustrating a structure of a storage control node according to an embodiment of the present invention.

FIG. 6 shows a schematic view illustrating a structure of a storage control node according to another embodiment of the present invention.

FIG. 7 shows a schematic view illustrating a structure of a storage control node according to still another embodiment of the present invention.

FIG. 8 shows a e schematic view of illustrating a structure a distributed storage system according to an embodiment of the present invention.

### DETAILED DESCRIPTION

Hereinafter, the technical solutions of embodiments of the present invention will be described clearly and completely with reference to the accompanying drawings thereof. It is obvious that the described embodiments are only part of embodiments of the invention but not all of embodiments. Based on embodiments of the present invention, all other embodiments obtained by those of ordinary skill in the art without making creative work are within the scope of the present invention.

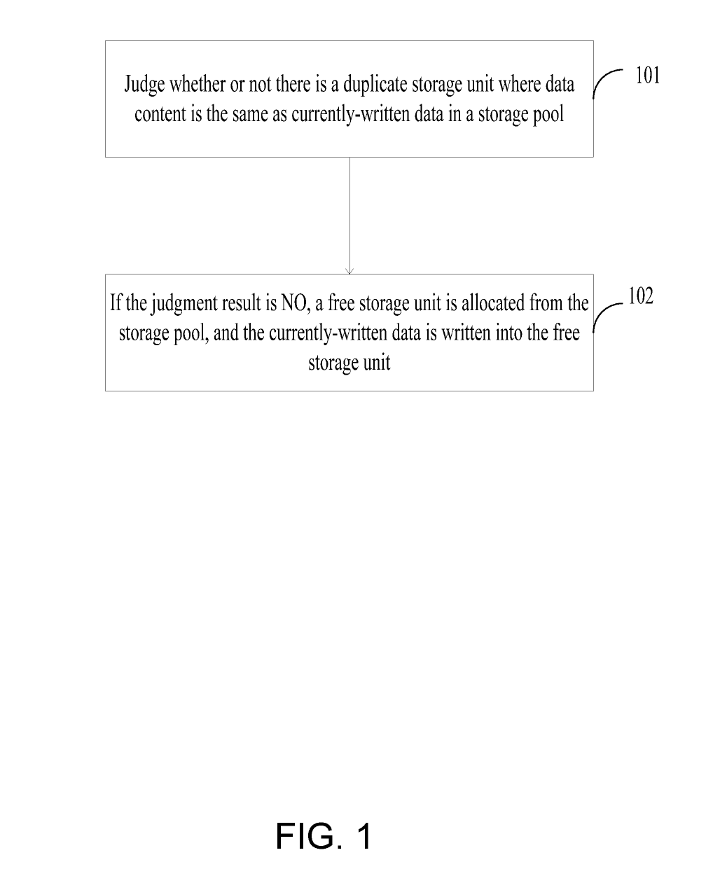

FIG. 1 shows a schematic flowchart of a storage method according to an embodiment of the present invention. The storage method is applied to a distributed storage system comprising at least two storage control nodes and one storage pool shared by the at least two storage control nodes. The storage pool comprises at least two storage units. The method comprises:

Step 101: judging whether or not there is a duplicate storage unit where data content is the same as the currently-written data in the storage pool when the currently-written data is to be written into the storage pool by any one of the storage control nodes.

When there is a duplicate storage unit in the storage pool, it means that the currently-written data has been stored in the storage pool, and it is unnecessary to rewrite the currently-written data.

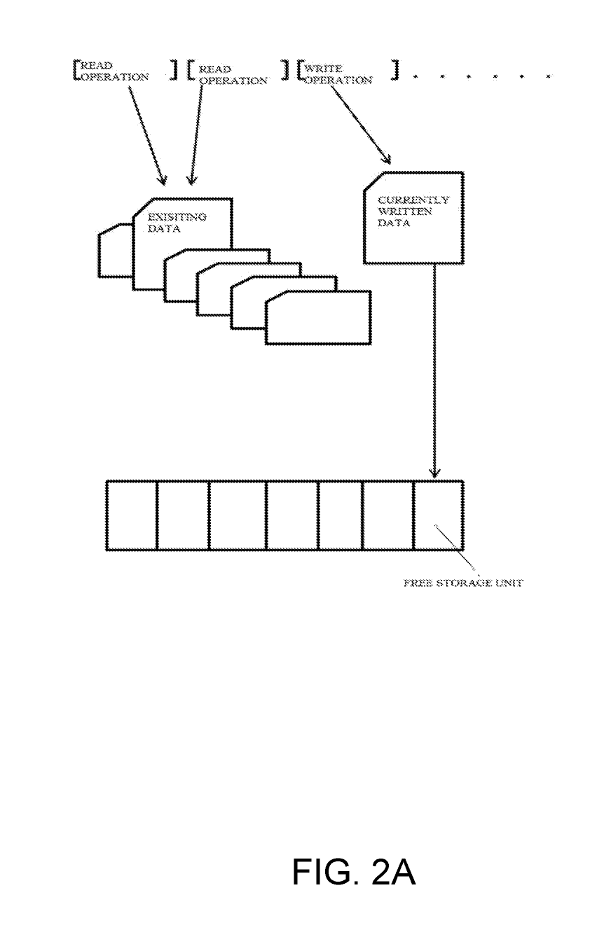

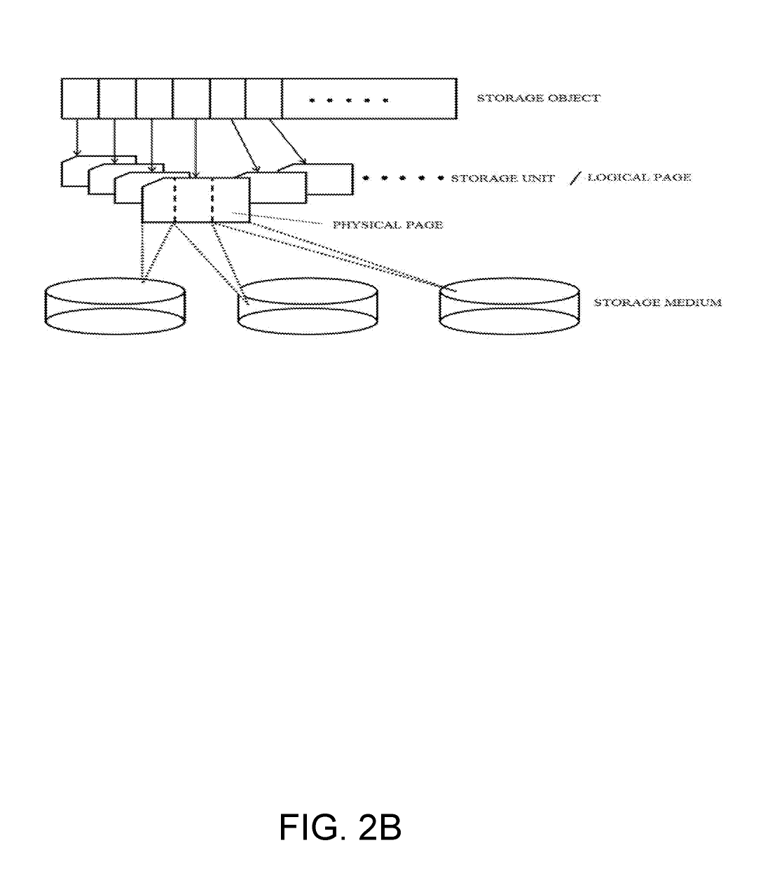

Step 102: allocating one free storage unit from the storage pool and writing the currently-written data to the free storage unit when the judgment result is NO, as shown in FIG. 2A.

When there is no duplicate storage unit in the storage pool, it means that the currently-written data is new data content that is not stored in the storage pool. By first allocating one free storage unit, locking it and then writing the new data into it, it can be guaranteed that no other storage control nodes write data to the same storage unit. Thus, there is no conflict between read operations and write operations, and between write and write operations by the storage method according to the embodiment of the present invention, thereby effectively ensuring efficiency and quality of data content storage. In addition, the judging process of the duplicate storage unit avoids duplicate storage of data content, saves storage space, and improves the utilization efficiency of storage resources.

Although the process of performing write operations on only one storage unit is shown in FIG. 2A, in an embodiment of the present invention, one or more storage units may constitute one storage object. In this way, when write operations are to be performed on one storage object in the storage pool by one storage control node, it is necessary to judge whether or not there is a duplicate storage unit for each of the plurality of storage units included in the storage object, and write data of the storage unit where there is no duplicate storage unit in the storage object into the free storage unit in the storage pool.

In an embodiment of the present invention, the storage pool may be pre-divided into a plurality of storage units each of which occupies the same storage space. In a further embodiment, the storage unit may be one storage concept at the logical level. As shown in FIG. 2B, one storage unit may be one logical page, and one logical page may include at least one physical page, the at least one physical page may be distributed in at least one storage medium. In this way, when one or more storage units constitute one storage object, at the logical level, different storage units in one storage object are continuous, but at the physical level, the physical page corresponding to the storage object may be distributed in a plurality of storage media in the storage pool. In a further embodiment, in order to improve reading and writing efficiency for the storage unit, at least one physical page corresponding to one logical page may be distributed in different storage medium; in order to realize a disaster recovery mechanism at the physical level to ensure data storage security, at least one physical page corresponding to one logical page may save data content in the way of redundancy storage (for example, RAID or Erasure Code).

Furthermore, it should be understood that a storage address corresponding to the storage unit may also be one concept at the logical level, which corresponds to one logical page; one storage address may also include at least one actual physical address, and the at least one physical address may be discontinuous, which correspond to different physical pages respectively. Thus, when write operations are performed on one storage unit in the storage pool, it is practically possible to perform write operations on a plurality of physical pages distributed in different storage media of the storage pool. In this way, hardware resources of the different storage media can be shared simultaneously in the subsequent read and write operations to improve reading and writing efficiency, and data reliability and availability can be improved by redundancy storage method. Thus, data can be read and written normally in the event of some storage media failure.

It should also be understood that storage objects may correspond to different specific forms when the storage method according to embodiments of the present invention is applied to different distributed storage system architectures. For example, the storage object may be a block device, a file in a file system, or an object in an object distributed storage system, etc. The present invention does not limit the specific forms of the storage object.

In an embodiment of the present invention, each storage control node is able to access all the storage units in the storage pool without other storage control nodes, so that all of the storage media of the present invention are actually shared by all of the storage control nodes, thereby realizing effect of global storage pool. In a further embodiment, the effect of global storage pool described above may be implemented by a storage network. In particular, the distributed storage system may further comprise a storage network. At least two storage nodes and at least one storage medium are respectively connected to the storage network, and each storage control node accesses the storage unit in the storage pool through the storage network. The storage network is configured such that each storage control node can access all the storage media without other storage control nodes.

In an embodiment of the present invention, the storage network may include at least one storage switching device. The access to the storage medium by the storage control nodes is realized via data exchange between the storage switching devices included in the storage network. Specifically, the storage control nodes and the storage pool are respectively connected to the storage switching device through storage channels.

In another embodiment of the present invention, the storage network may include at least two storage switching devices, and each storage control node may be connected to of any one of the storage media by any one of the storage switching devices. When any of the storage switching devices or the storage channels connected to one storage switching device fails, the storage control nodes read data from the storage medium and write data to the storage medium through other storage switching devices.

In an embodiment of the present invention, the storage switching device may be any one of a Serial Attached SCSI (SAS) switch, a PCI/e switch, an Omni Path switch, an Infiniband switch, an Ethernet switch and a TLink switch, and correspondingly, the storage channel may be any one of a SAS, a PCI/e channel, an Omni Path channel, an Infiniband channel, an Ethernet channel and a TLink channel.

In an embodiment of the present invention, the storage pool comprises at least one storage device connected to the storage network, each storage device comprises at least one storage medium, the physical machine where the storage control nodes are located is independent from the storage device, and the storage device is used more as a channel for connecting the storage media and the storage networks. In this way, it is unnecessary to migrate physical data in different storage media when dynamic balancing is required, and it is only necessary to balance the storage medium managed by different storage control nodes through configurations.

In another embodiment of the present invention, the storage control node side further comprises computing nodes, and the computing nodes and the storage control nodes are arranged in one physical server, which is connected to the storage device through the storage network. According to embodiments of the present invention, the distributed shared storage system where the computing nodes and the storage control nodes are located on the same physical machine can reduce the number of physical devices as a whole, thereby reducing the cost. Furthermore, the computing nodes can also locally access the storage resources as wish. In addition, because the computing nodes and the storage control nodes are aggregated in the same physical server, the data exchange between the computing nodes and the storage control nodes can be simplified into just memory sharing, and performance is particularly outstanding.

In an embodiment of the present invention, the storage medium may include, but is not limited to, a hard disk, a flash memory, a SRAM, a DRAM, a NVME, or other form, the access interface of the storage medium may include, but is not limited to, a SAS interface, a SATA interface, a PCI/e interface, a DIMM Interface, a NVMe interface, a SCSI interface, and an AHCI interface.

In an embodiment of the present invention, the storage control node needs to return the actual storage addresses of the currently-written data to the invoker when the written data operations of the storage control nodes are invoked. And the actual storage addresses of the currently-written data are different depending on the presence or absence of the duplicate storage units. In this case, it is necessary to return the different storage addresses to the invoker depending on the judgment result on whether or not there is a duplicate storage unit.

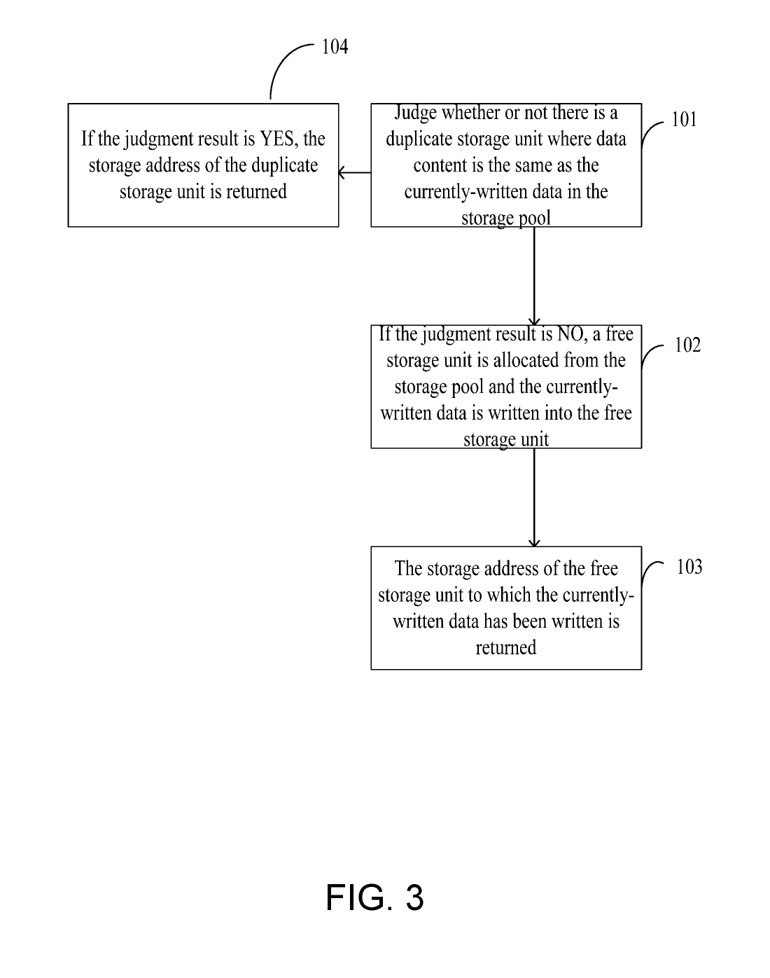

FIG. 3 shows a schematic flowchart of a storage method according to an embodiment of the present invention. When the written data operations of the storage control nodes are invoked, as compared with the storage method shown in FIG. 1, the storage method shown in FIG. 3 further comprises:

Step 103: returning the storage address of the free storage unit to which the currently-written data has been written if the judgment result is NO.

When there is no duplicate storage unit, the actual storage address of the currently-written data is the storage address of the written free storage unit, and therefore, it is necessary to return the storage address of the free storage unit to the invoker so that the invoker can locate the currently-written data.

Step 104: returning the storage address of the duplicate storage unit if the judgment result is YES.

When there is a duplicate storage unit, the currently-written data is not actually written to the storage pool. Since the data contents of the duplicate storage unit are the same as the currently-written data, the storage address of the duplicate storage unit is returned to the invoker, thereby ensuring that the invoker locates to the same data contents as the currently-written data.

In an embodiment of the present invention, when one or more storage units constitute one storage object, the storage address of each storage unit in the storage object can be recorded in metadata of the storage objects. When the storage addresses of the storage unit are changed in the current write operations, the metadata of the storage object is updated in real time. For example, when a write operation is performed on one storage object and it is found that there is a duplicate storage unit in one storage unit, the storage address of the storage unit is updated to the storage address of the duplicate storage unit in the metadata of the storage object. For the storage unit where there is no duplicate storage unit in the storage object, it means that the data contents of the storage unit have been changed with respect to the original data contents. Since the currently-written data of these storage units is written into the free storage units, the storage addresses of the storage units are updated to the storage addresses of the written free storage units in the metadata of the storage object. In this way, the updated storage address can be obtained from the updated metadata when the data contents of the storage unit whose storage address is changed in the storage object are read in the subsequent read operations. And the updated storage unit is released from the current storage object. When a storage unit no longer belongs to any storage object, the storage object can be recycled and reused. The specific recycling mechanism is described in the subsequent embodiments.

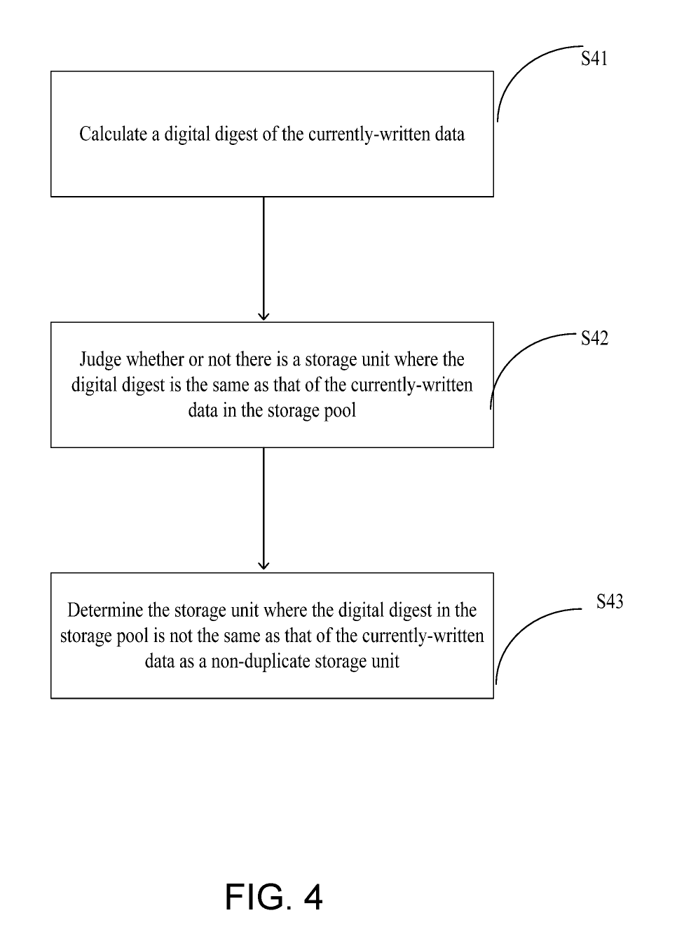

In an embodiment of the present invention, as shown in FIG. 4, the above process of judging whether or not there is a duplicate storage unit can be specifically implemented by the following process: first calculating a digital digest of the currently-written data (S41); judging whether or not there is a storage unit in the storage pool where the digital digest is the same as that of the currently-written data (S42); and determining the storage unit where the digital digest is not the same as that of the currently-written data in the storage pool as a non-duplicate storage unit (S43). Since the storage unit where the digital digest is not the same as that of the currently-written data is certainly not a duplicate storage unit, the judging process reduces the range of judging the duplicate storage unit in the storage pool and improving judging efficiency. In an embodiment of the present invention, the storage unit where the digital digest in the storage pool is the same as that of the currently-written data may be determined as a duplicate storage unit.

Alternatively, the digital digest may be combined with other judging methods to judge the duplicate storage unit. For example, in an embodiment of the present invention, taking into account that the digital digest does not fully represent the data contents of the storage unit since there is still a small probability that the same digital digest is calculated from different data contents, in order to avoid missing the currently-written data, even if the judgment result of the digital digest is the same, it is still necessary to verify whether or not the data contents of the storage unit where the digital digest is the same as that of the currently-written data is the same as the currently-written data. Only when the data contents comparison result is also the same, the storage unit where the data digest comparison result is the same can be determined as a duplicate storage unit.

In an embodiment of the present invention, the digital digest of the storage unit or the currently-written data may be in the form of a string, and a method for acquiring the digital digest comprises: selecting one character set consisting of N characters; calculating a digital digest in binary form, wherein the specific algorithm for calculating the digital digest in binary form can be pre-selected as required, and the invention is not limited thereto; converting the digital digest in binary form into the digital digest in N-ary form; and converting the digital digest in N-ary form into a character string. The converting method converts each bit of the digital digest in N-ary form into one corresponding character in the character set. The pre-set fixed-length character set can simplify the contents of the binary digital digest, thus further simplifying the judging process of the duplicate storage unit and improving the judging efficiency.

It should be understood that that the above judging process for the duplicate storage unit may have different specific implementations when the storage method according to embodiments of the present invention is applied to different distributed storage system architectures. For example, when a file system is established in the storage pool, each storage unit is one file in the file system, and a filename of the file is the digital digest of the storage unit. In this case, the process of judging whether or not there is a duplicate storage unit is actually to judge whether or not there is a file whose filename is the same as the digital digest of the currently-written data.

As described above, with the constant write operations to the storage unit in the storage pool, the storage unit included in one storage object is constantly updated, and the updated storage unit is released from the original storage object. And when one storage unit no longer belongs to any of the storage objects, the storage unit can be recycled as a free storage unit for subsequent write operations.

In an embodiment of the present invention, a reference count for each storage unit in the storage pool can be recorded. Each time the judgment result on whether or not there is a duplicate storage unit is YES, it means that the duplicate storage unit is added to a storage object again, and in this case the reference count of the duplicate storage unit is increased. And each time one storage unit is released, the reference count of the storage unit is reduced. In a further embodiment of the present invention, when a reference count of one storage unit is reduced to zero, it means that the storage unit no longer belongs to any storage object, the storage unit is recorded as a free storage unit, thereby realizing recycling of storage space in the storage pool.

In an embodiment of the present invention, the reference count for each storage unit in the storage pool can be recorded by a record table, the initial value of which is zero. Since each storage unit corresponds to one storage address, the record table also records the reference count for each storage address in the storage pool. When storage address of each storage unit in the storage object is recorded by using the metadata of the storage object, the reference count of the storage address is incremented by one each time one storage address is updated to metadata of one storage object; the reference count of the storage address is decremented by one each time one storage address is deleted from metadata of one storage object. For example, one storage system includes two storage objects S1 and S2, one storage object S1 includes four storage units, the corresponding storage addresses are ABCD; and the other storage object S2 also includes four storage units, the corresponding storage addresses are respectively EBFG It can be seen that the B storage address is shared by S1 and S2. In this case, the reference count of the several storage addresses ABCDEFG recorded by the record table is 1211111. When the write operations are performed once on S1 and S2 respectively, the storage address in the metadata of S1 is updated to AHCD, where the B address is deleted; and the storage address in the metadata of S2 is updated to EIJG where the B address and F address are deleted. In this case, the reference count of the several storage addresses ABCDEFG recorded by the record table becomes 1011101, where the reference count of B address and F address is reduced to zero, which means that the storage unit corresponding to the B address and the storage unit corresponding to F address are not occupied by any storage object and can be used for recycling.

In an embodiment of the present invention, as described above, when one storage control node writes the currently-written data to one free storage unit of the storage pool, one free storage unit should be allocated from the storage pool firstly. Considering that there is conflict when different storage control nodes acquire a free storage unit from the storage pool simultaneously, at least two reserved free storage spaces can be set in the storage pool, where each of which corresponds to one storage control node. Thus, when one storage control node writes the currently-written data to one free storage unit of the storage pool, one free storage unit is actually allocated from the reserved free storage space corresponding to the storage control node, and therefore there is no conflict with the writing process of other storage control nodes.

In a further embodiment, in order to ensure that there is always a sufficient number of free storage units in a reserved free storage space corresponding to one storage control node, when the size of the reserved free storage space corresponding to one storage control node is less than a first threshold, at least one free storage unit in the storage pool to a reserved free storage space. For example, suppose that a reserved free storage space corresponding to one storage control node includes at most N free storage units, where N is an integer greater than or equal to 2; when the number of free storage units in the reserved free storage space is less than M, N-M free storage units are acquired from the storage pool to supplement the reserved free storage space, where M is an integer less than N and more than zero.

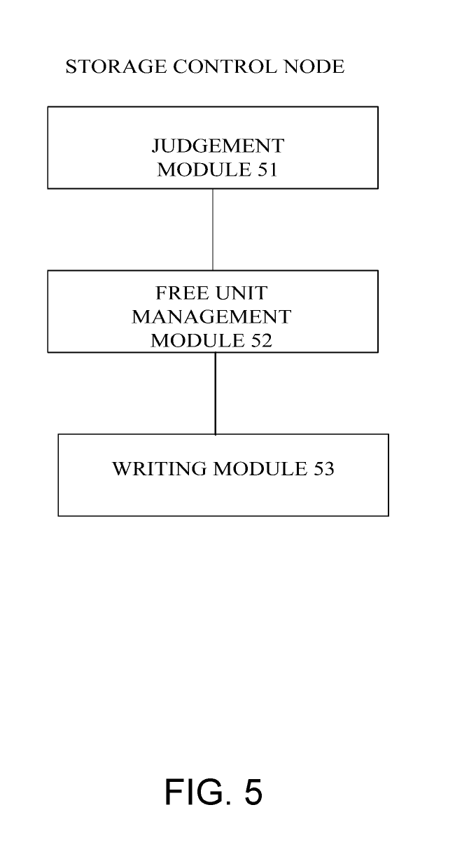

An embodiment of the present invention provides a distributed storage system comprising at least two storage control nodes and a storage pool shared by the at least two storage control nodes. As shown in FIG. 5, the storage control node comprises: a judgment module 51 configured to judge whether or not there is a duplicate storage unit where data content is the same as currently-written data in the storage pool; a free unit management module 52 configured to allocate one free storage unit from the storage pool; and a writing module 53 configured to return the storage address of the duplicate storage unit if the judgment result returned by the judgment module 51 is YES; otherwise to write the currently-written data to the free unit allocated by the free unit management module 52, and to return the storage address of the free storage unit to which the currently-written data has been written.

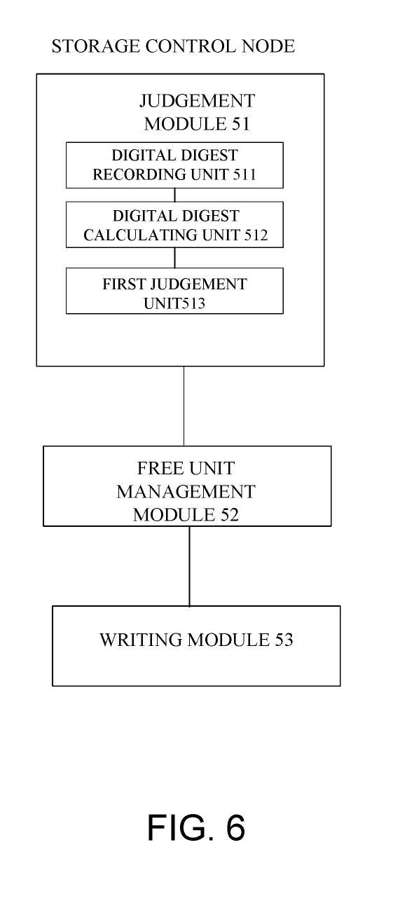

In an embodiment of the present invention, as shown in FIG. 6, the judgment module 51 comprises: a digital digest recording unit 511 configured to record digital digests of all the storage units; a digital digest calculating unit 512 configured to calculate a digital digest of the currently-written data; a first judgment unit 513 configured to judge whether or not there is a digital digest having the same digital digest as the currently-written data in the digital digest recording unit, and determine the storage unit in the digital digest recording unit where the digital digest is not the same as that of the currently-written data as a non-duplicate storage unit.

In an embodiment of the present invention, the judgment module 51 further comprises: a verification unit configured to verify whether or not data contents of the storage unit where the digital digest is the same as that of the currently-written data are the same as that of the currently-written data before the storage unit where the digital digest is the same as that of the currently-written data in the digital digest recording unit is determined as the duplicate storage unit.

In an embodiment of the present invention, a file system is established in the storage pool, each of the storage units is a file in the file system, the filename of the file is a digital digest of the storage unit. The first judgment unit 513 in the judgment module 51 is further configured to judge whether or not there is a file that has the same filename as the digital digest of the currently-written data in the file system.

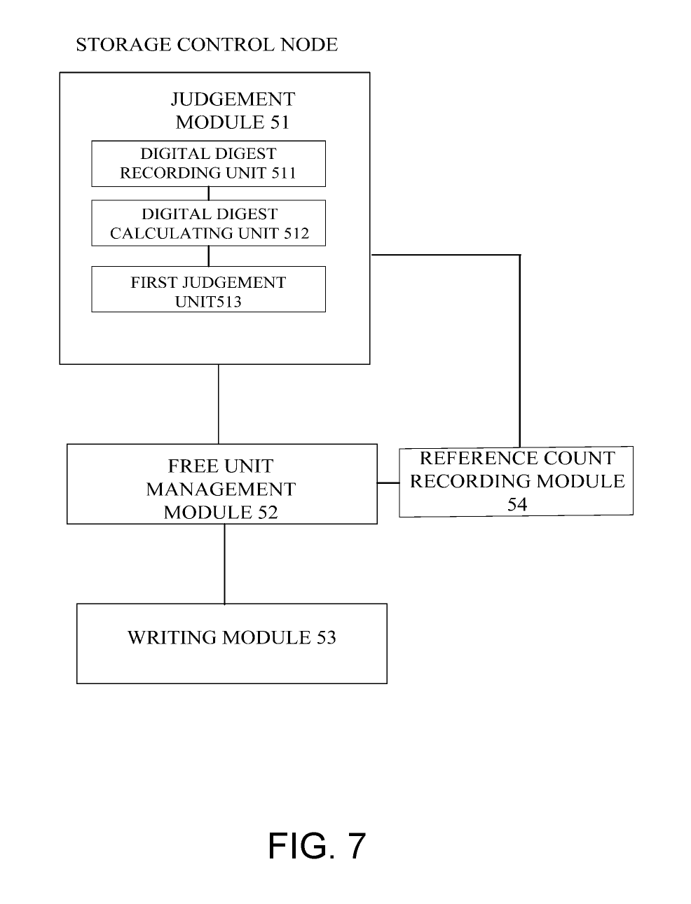

In an embodiment of the present invention, as shown in FIG. 7, the storage control node further comprises: a reference count recording module 54 configured to record a reference count for each storage unit in the storage pool; wherein the reference count of the duplicate storage unit is increased each time the judgment result returned by the judgment module 51 is YES; the reference count of the storage unit is reduced each time a storage unit is released; wherein the free unit management module 52 is further configured to record the storage unit as one free storage unit when the reference count of one of the storage units recorded by the reference count recording module 54 is reduced to zero.

In an embodiment of the present invention, the storage pool includes at least two reserved free storage spaces, wherein each reserved free storage space corresponds to one storage control node; wherein the free unit management module 52 is further configured to allocate the free storage units from the reserved free storage space corresponding to the storage control nodes.

In an embodiment of the present invention, each storage control node is able to access all of the storage units in the storage pool without other storage control nodes.

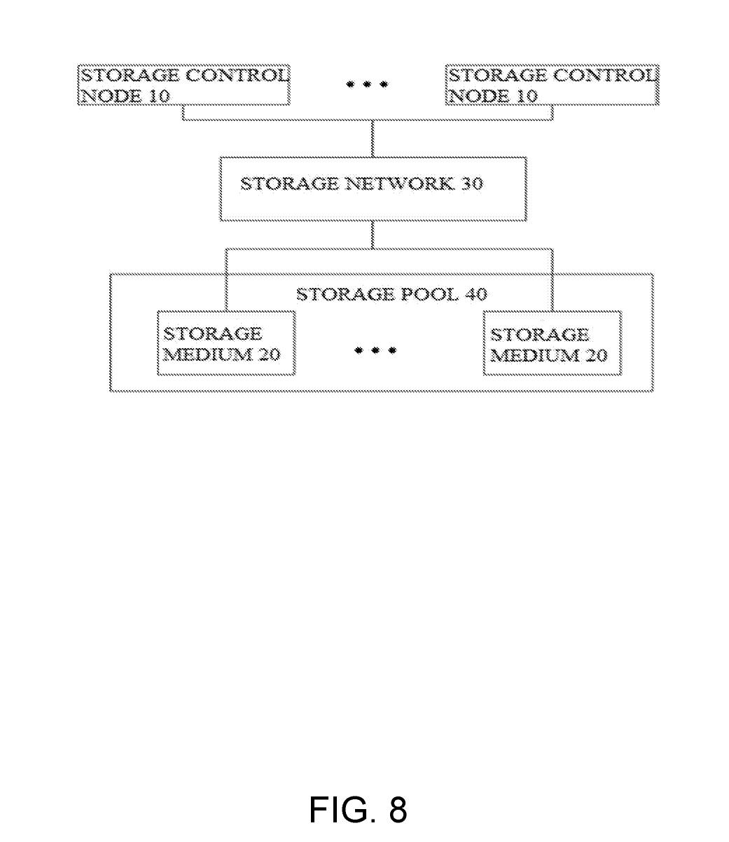

In an embodiment of the present invention, as shown in FIG. 8, the distributed storage system comprises a storage network 30, at least two storage nodes 10 and at least one storage medium 20 connected to the storage network 30 respectively. The storage pool 40 includes at least one storage medium 20. Each storage control node 10 accesses the storage medium 20 in the storage pool 40 through the storage network 30.

It will be understood that each module or unit described in the distributed storage system according to the above embodiments corresponds to one of the above method steps. Thus, the operations and features described in the above method steps are applicable to the distributed storage system and the corresponding modules and units contained therein. The repetitive contents are not repeated here.

The teachings of the embodiments of the present invention may also be implemented as a computer program product of a computer readable storage medium, including computer program codes when executed by a processor, causes the processor to implement the storage method such as implementations herein, in accordance with the method of embodiments of the present invention. The computer storage medium may be any tangible medium, such as a floppy disk, a CD-ROM, a DVD, a hard disk drive, or even a network medium.

It should be understood that although the foregoing has been described that one implementation of embodiments of the present invention may be a computer program product, the method or apparatus of embodiments of the present invention may be implemented in software, hardware, or a combination of software and hardware. The hardware part may be implemented using dedicated logic; the software part may be stored in storage and executed by an appropriate instruction execution system, such as a microprocessor or a dedicated design hardware. It will be appreciated by those of ordinary skill in the art that the above methods and devices may be implemented using computer-executable instructions and/or being contained in processor control codes, which are provided by for example a carrier medium such as a disk, a CD or a DVD-ROM, a programmable memory such as a read-only memory (firmware) or a data carrier such as an optical or electronic signal carrier. The method and apparatus of the present invention may be implemented by a hardware circuit (such as a super large scale integrated circuit or gate array, a semiconductor such as a logic chip, a transistor, or a programmable hardware device such as a field programmable gate array, a programmable logic device), or may be implemented by software implemented by various types of processors, or by the combination of the above hardware circuit and software, such as firmware.

It should be understood that although several modules or units of the device are mentioned in the detailed description above, such division is merely exemplary and not mandatory. In fact, according to exemplary embodiments of the present invention, the features and functions of two or more modules/units described above may be implemented in one module/unit, whereas the features and functions of one module/unit described above can be further divided into multiple modules/units. In addition, some of the modules/units described above may be omitted in some application scenarios.

It should be understood that, in order not to obscure embodiments of the present invention, the specification describes only some key techniques and features, and may omit some features which can be achieved by those skilled in the art.

The foregoing is intended only as preferred embodiments of the invention and is not intended to be limiting of the invention, and any modifications, equivalent substitutions, etc., within the spirit and principles of the invention are intended to be included within the scope of the present invention.

What is claimed is:

1. A storage method applied to a distributed storage system comprising at least two storage control nodes and a storage pool shared by the at least two storage control nodes, the storage pool including at least two storage units, the method comprising:
judging whether or not there exists a duplicate storage unit whose data content is the same as currently-written data in the storage pool when the currently-written data is to be written into the storage pool by any one of the storage control nodes, and
allocating a free storage unit from the storage pool and writing the currently-written data into the free storage unit when the judgment result is NO.

2. The method according to claim 1, further comprising:
returning a storage address of the free storage unit to which the currently-written data has been written if the judgment result is NO when write operations of the storage control node is invoked; and
returning a storage address of the duplicate storage unit if the judgment result is YES.

3. The method according to claim 1, wherein judging whether or not there exists a duplicate storage unit whose data content is the same as currently-written data in the storage pool comprises:
calculating a digital digest of the currently-written data;
judging whether or not there exists a storage unit whose digital digest is the same as that of the currently-written data in the storage pool; and
determining the storage unit whose digital digest is not the same as the digital digest of the currently-written data as a non-duplicate storage unit.

4. The method according to claim 3, wherein the digital digest is in the form of a string, and calculating the digital digest comprises:
selecting one character set consisting of N characters;
calculating a digital digest in binary form;
converting the digital digest in binary form into N-ary form; and
converting the digital digest in N-ary form into a character string, wherein each bit of the digital digest in N-ary form is converted into the corresponding character in the character set based on the value of the bit.

5. The method according to claim 1, wherein a file system is established in the storage pool, each of the storage units is one file in the file system, and the filename of a file is the digital digest of the storage unit; and
wherein judging whether or not there is a duplicate storage unit whose data content is the same as currently-written data in the storage pool comprises:
judging whether or not there is a file whose filename is the same as the digital digest of the currently-written data in the file system.

6. The method according to claim 1, further comprising:
recording the reference count for each storage unit in the storage pool;
increasing the reference count of the duplicate storage unit each time the judgment result is YES; decreasing the reference count of a storage unit each time the storage unit is released.

7. The method according to claim 6, further comprising:
recording a storage unit as free storage unit when the reference count of the storage unit is reduced to zero.

8. The method according to claim 1, wherein the storage pool includes at least two reserved free storage spaces, where each of the reserved free storage space comprises at least one free storage unit and corresponds to one storage control node; wherein allocating one free storage unit from the storage pool comprises:
allocating one storage unit from the reserved free storage space corresponding to the storage control node which is writing data.

9. The method according to claim 8, further comprising:
allocating at least one free storage unit in the storage pool to a reserved free storage space when the size of the reserved free storage space is less than a first threshold.

10. The method according to claim 1, wherein the storage pool is pre-divided into a plurality of storage units each of which occupies the same size.

11. The method according to claim 1, wherein one or more of the storage units constitute one storage object, the type of a storage object includes block device, file in a file system and object in an object storage system.

12. The method according to claim 1, wherein each of the storage control nodes is able to access all the storage units in the storage pool without the help of other storage control nodes.

13. The method according to claim 12, wherein the distributed storage system further includes a storage network, the at least two storage nodes and the storage pool are respectively connected to the storage network, and each of the storage control nodes accesses the storage pool via the storage network.

14. A distributed storage system including at least two storage control nodes and a storage pool shared by the at least two storage control nodes, the storage control node comprising:
a judgment module configured to judge whether or not there is a duplicate storage unit in the storage pool where data content is the same as currently-written data;
a free unit management module configured to allocate a free storage unit from the storage pool; and
a writing module configured to return a storage address of the duplicate storage unit when the judgment result returned by the judgment module is YES; otherwise to write the currently-written data to the free storage unit allocated by the free unit management module, and return the storage address of the free storage unit to which the currently-written data has been written.

15. The system according to claim 14, wherein the judgment module comprises:
a digital digest recording unit configured to record digital digests of all the storage units;
a digital digest calculating unit configured to calculate a digital digest of the currently-written data;
a first judgment unit configured to judge whether or not there is a digital digest that is the same as the digital digest of the currently-written data in the digital digest recording unit, and determine the storage unit in the digital digest recording unit where the digital digest is not the same as that of the currently-written data as a non-duplicate storage unit.

16. The system according to claim 14, wherein a file system is established in the storage pool; each of the storage units is a file in the file system; the filename of the file is a digital digest of the storage unit;
wherein the first judgment unit of the judgment module is further configured to judge whether or not there is a file that has the same filename as the digital digest of the currently-written data in the file system.

17. The system according to claim 14, further comprising:
a reference count recording module configured to record a reference count for each storage unit in the storage pool; wherein the reference count of the duplicate storage unit is increased each time the judgment result returned by the judgment module is YES; the reference count of one storage unit is reduced each time the storage unit is released;
wherein the free unit management module is further configured to record the storage unit as one free storage unit when the reference count of one of the storage units recorded by the reference count recording module is reduced to zero.

18. The system according to claim 14, wherein the storage pool includes at least two reserved free storage spaces, where each of the reserved free storage space corresponds to one storage control node; and
wherein the free unit management module is further configured to allocate the free storage unit from the reserved free storage space corresponding to the storage control node.

19. The system according to claim 14, wherein each of the storage control nodes is able to access all the storage units in the storage pool without other storage control nodes.

20. The system according to claim 19, further comprising a storage network, wherein the at least two storage nodes and at least one storage pool are respectively connected to the storage network, the storage pool is consisted of the at least one storage medium, and each of the storage control nodes accesses the storage medium in the storage pool through the storage network.
